(19) United States
(12) Patent Application Publication
(10) Pub. No.: US 2010/0239241 A1
(43) Pub. Date: Sep. 23, 2010

(54) Surveillance camera mounting structure

(75) Inventor: Zu-Jyun Chou, Taipei (TW)

Correspondence Address: BACON & THOMAS, PLLC, 625 SLATERS LANE, FOURTH FLOOR, ALEXANDRIA, VA, 22314-1176, US

(73) Assignee: CHAINS TECHNOLOGY CO., LTD., Taipei (TW)

(21) Appl. No.: 12/382,710

(22) Filed: Mar. 23, 2009

(51) Int. Cl. G03B 17/00

(52) U.S. Cl. 396/427

(57) ABSTRACT

A surveillance camera mounting structure includes a casing for accommodating a circuit board, a cover hinged to one side of the casing for closing the casing and having a front shield for accommodating an image sensor, a safety cord member connected between the casing and the cover to prohibit falling of the cover from the casing when the cover is opened from the casing, a mounting plate affixed to the back side of the casing, and binding straps inserted through insertion slots on the mounting plate for fastening the mounting plate to a post.

### BACKGROUND OF THE INVENTION

1. Field of the Invention

The present invention relates to surveillance systems and more specifically, to a surveillance camera mounting structure, which facilitates installation and maintenance of the surveillance camera.

2. Description of the Related Art

Surveillance cameras of security systems are generally fixedly installed at selected locations at certain elevations for protection against thieves. For example, a surveillance camera may be mounted on a street lamppost. It is complicated to install a surveillance camera firmly at a high place. It is also difficult to maintain and repair a surveillance camera that is installed at a high place. Therefore, it is desirable to provide a surveillance camera mounting structure, which facilitates mounting and dismounting of a surveillance camera.

### SUMMARY OF THE INVENTION

The present invention has been accomplished under the circumstances in view. It is one object of the present invention to provide a surveillance camera mounting structure, which facilitates installation and maintenance of the surveillance camera.

To achieve this and other objects of the present invention, the surveillance camera mounting structure comprises a casing for accommodating a circuit board, a cover hinged to one side of the casing for closing the casing and having a front shield for accommodating an image sensor, a safety cord member connected between the casing and the cover to prohibit falling of the cover from the casing when the cover is opened from the casing, a mounting plate affixed to the back side of the casing, and binding straps inserted through insertion slots on the mounting plate for fastening the mounting plate to a post.

Further, the mounting plate has two serrated edges respectively formed on the free end of each of two side flanges thereof for stopping against the periphery of the post to which the binding straps are fastened, enhancing mounting tightness.

### BRIEF DESCRIPTION OF THE DRAWINGS

FIG. 1 is an elevational view of a surveillance camera mounting structure in accordance with the present invention.

FIG. 2 is an exploded view of the surveillance camera mounting structure in accordance with the present invention.

FIG. 3 is a sectional top view of the surveillance camera mounting structure in accordance with the present invention.

FIG. 4 corresponds to FIG. 3, showing the cover opened.

### DETAILED DESCRIPTION OF THE PREFERRED EMBODIMENT

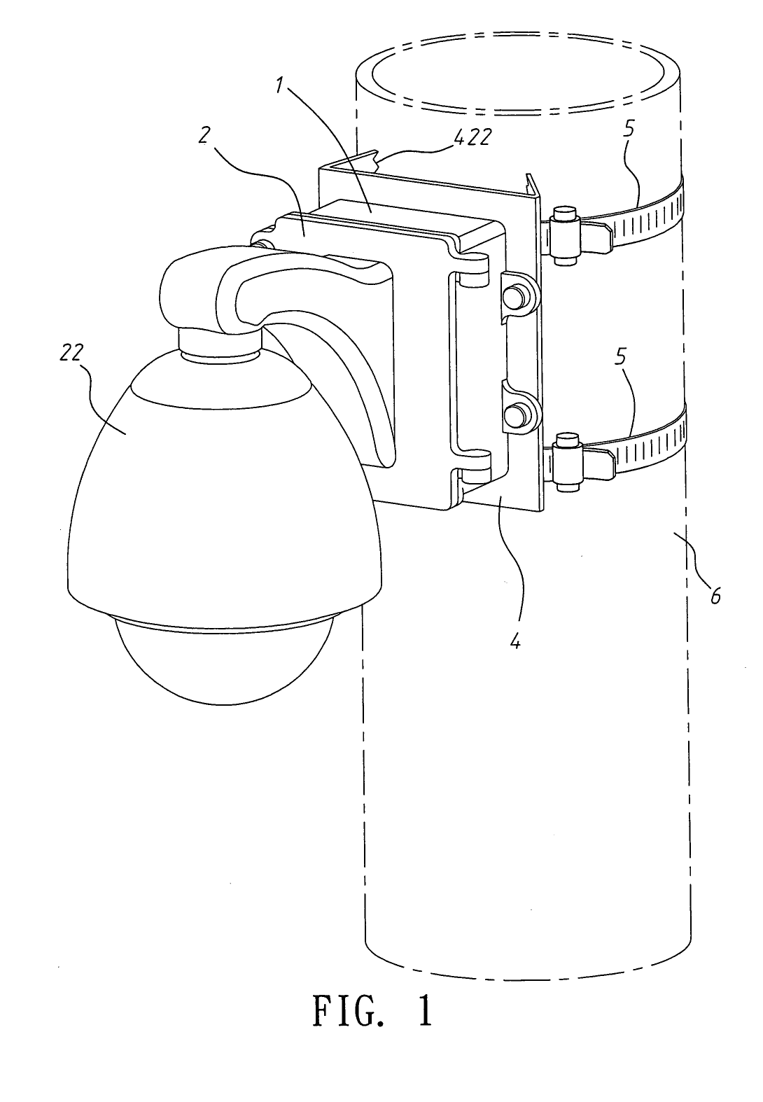

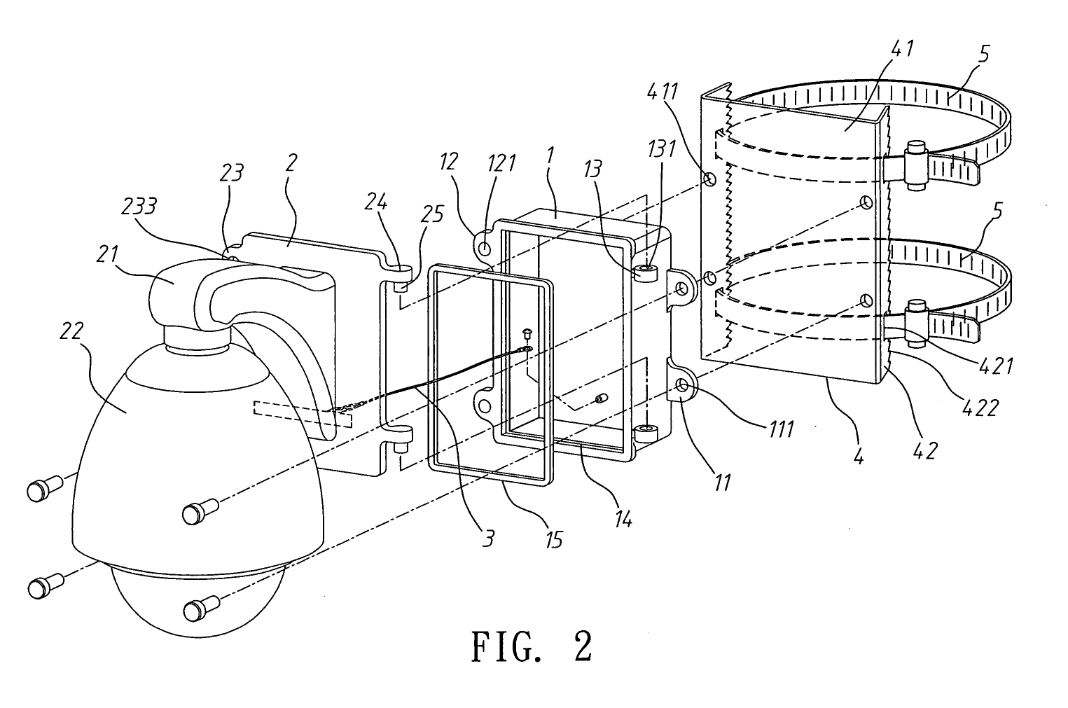

Referring to FIGS. 1 and 2, a surveillance camera mounting structure in accordance with the present invention is shown comprising: a casing 1, a cover 2, a safety cord member 3, a mounting plate 4, and two binding straps 5.

The casing 1 is a rectangular box member comprising two pairs of rear lugs 11 symmetrically protruded from the two opposite sidewalls at the rear side, a mounting through hole 111 formed on each rear lug 11, two front mounting 12 protruded from one sidewall at the front side, a screw hole 121 formed on each front lug 12, two pivot holders 13 protruded from the other sidewall at the front side, and a step 14 formed on the inside wall and extending around the front open side for accommodating a rubber packing member 15.

The cover 2 is adapted to close the front open side of the casing 1, comprising a front suspension arm 21 forwardly extended from the front side, a shield 22 located on the front side of the front suspension arm 21 for holding the image sensor of a surveillance camera, two lugs 23 disposed at one lateral side at different elevations, a through hole 231 formed on each lug 23, two protruding blocks 24 disposed at the other lateral side at different elevations, and a pivot pins 25 vertically downwardly extended from each protruding block 24.

The safety cord member 3 is connected between the cover 2 and the casing 1.

The mounting plate 4 is shaped like a channel bar, comprising a flat base wall 41, two side flanges 42 respectively perpendicularly extended from two opposite lateral sides of the flat base wall 41, a plurality of mounting through holes 411 cut through the front and back sides of the flat base wall 41 at two sides corresponding to the mounting through holes 111 of the casing 1, two elongated insertion slots 421 cut through each side flange 42 at different elevations, and a serrated edge 422 extending along the free end of each side flange 42.

The two binding straps 5 are respectively inserted through the elongated insertion slots 421 on the side flanges 42 of the mounting plate 4 and arranged at different elevations for fastening the mounting plate 4 to, for example, a post 6.

After installation of the circuit board of the surveillance camera in the casing 1, the pivot pins 25 of the cover 2 are respectively inserted into the pivot hole 131 defined in each of the two pivot holders 13 of the casing 1. Thus, the cover 2 and the casing 1 are hinged together. When the cover 2 is closed on the casing 1, screws (not shown) are respectively inserted through the through holes 231 on the lugs 23 of the cover 2 and threaded into the screw holes 121 on the front lugs 12 of the casing 1. Thereafter, fastening members (not shown) are respectively mounted in the mounting through holes 111 on the rear lugs 11 of the casing 1 and the mounting through holes 411 on the flat base wall 41 of the mounting plate 4 to affix the casing 1 to the mounting plate 4.

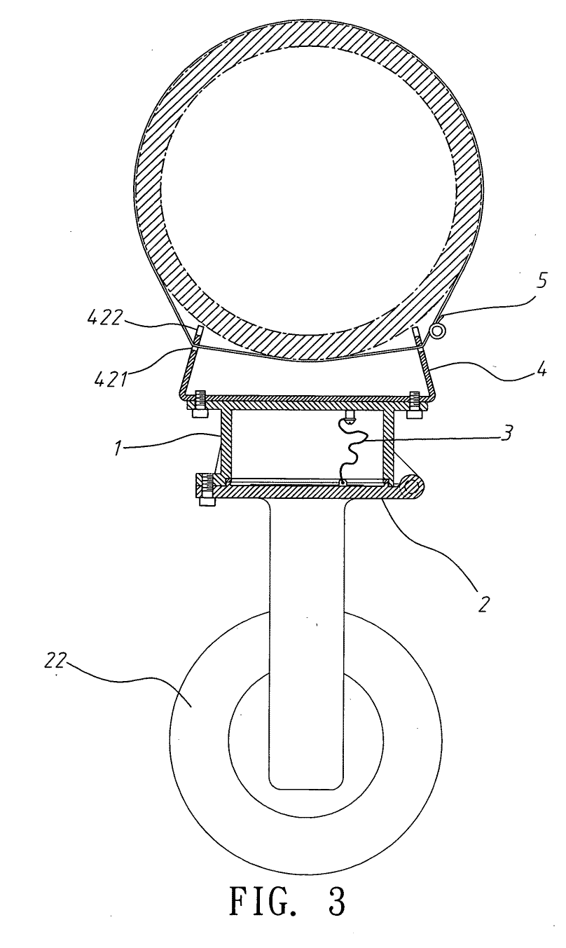

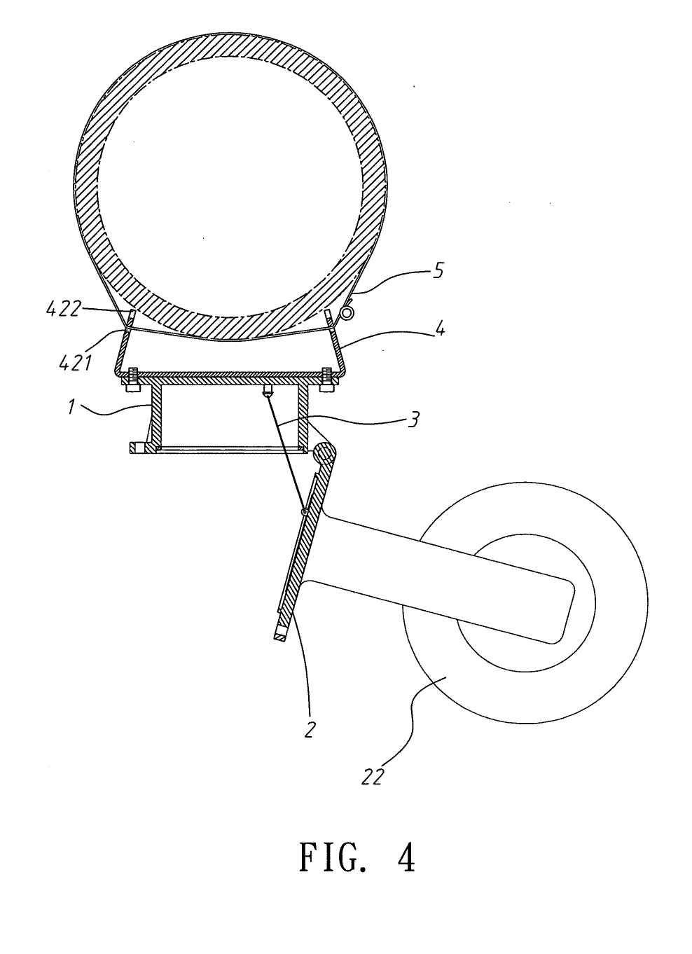

Referring to FIGS. 3 and 4 and FIGS. 1 and 2 again, when the cover 2 is closed on the casing 1, the back side of the cover 2 is stopped against the rubber packing member 15, sealing the casing 1 against outside moisture. During installation, the binding straps 5 are fastened the post 6 to affix the mounting plate 4 to the post 6. After installation, the serrated edges 422 of the side flanges 42 of the mounting plate 4 are stopped against the periphery of the post 6, enhancing mounting tightness. When a maintenance work is necessary, unfasten the screws from the through holes 231 of the cover 2 and the screw holes 121 of the casing 1, and then open the cover 2 for access to the circuit board in the casing 1. When the cover 2 is opened, the safety cord member 3 secures the cover 2 from falling down.

A prototype of surveillance camera mounting structure has been constructed with the features of FIGS. 1˜4. The surveillance camera mounting structure functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A surveillance camera mounting structure, comprising:
a casing for accommodating a circuit board, said casing comprising a plurality of axle housings arranged at one lateral side thereof;
a cover for closing said casing, said cover comprising a shield disposed at a front side thereof for accommodating an image sensor, and a plurality of pivot pins arranged at one lateral side thereof and respectively pivotally coupled to the axle housings of said casing for enabling said cover to be biased relative to said casing to close and open said casing;
a safety cord member connected between said casing and said cover to prohibit falling of said cover from said casing after said cover is opened from said casing;
a mounting plate affixed to a back side of said casing, said mounting plate comprising a plurality of insertion slots disposed at different elevations; and
a plurality of binding straps inserted through the insertion slots of said mounting plate for fastening said mounting plate to a post.

2. The surveillance camera mounting structure as claimed in claim 1, wherein said bottom plate comprises a plurality of serrated edges for stopping against the periphery of the post to which said binding straps are fastened.

3. The surveillance camera mounting structure as claimed in claim 1, wherein said casing comprises an inside step extending around a front open side thereof, and a flexible packing member mounted in said inside step for stopping against said cover to seal said casing against outside moisture when said cover is closed on said casing.
